(19) United States
(12) Patent Application Publication
(10) Pub. No.: US 2019/0217907 A1
(43) Pub. Date: Jul. 18, 2019

(54) Continuous Track Pieces and Associated Methods

(71) Applicant: John Lionel RENNIE, Lumby (CA)

(72) Inventor: John Lionel RENNIE, Lumby (CA)

(21) Appl. No.: 16/247,773

(22) Filed: Jan. 15, 2019

Related U.S. Application Data
(60) Provisional application No. 62/617,873, filed on Jan. 16, 2018.

(51) Int. Cl. B62D 55/253; B62D 55/205; B62D 55/24; B62D 55/26

(52) U.S. Cl. CPC B62D 55/253; B62D 55/26; B62D 55/244; B62D 55/205

(57) ABSTRACT

A track piece for a continuous track is disclosed. The track piece is rotationally asymmetric and comprises connectors which enable connection to an adjacent track piece of the same shape which has been rotated 180°. This may allow a track to be produced with multiple similarly shaped track pieces which has multiple track surfaces. This may also allow for a continuous track to be produced with a number of track pieces connected along a central band, wherein the track comprises spaced apart lateral track piece projections.

### CROSS-REFERENCE TO RELATED APPLICATIONS

This application claims priority to U.S. Provisional Application Number 62/617,873 filed on 16 Jan. 2018 which is hereby incorporated by reference in its entirety.

### FIELD OF THE INVENTION

The invention relates to continuous (or caterpillar) track pieces and, in particular, to those used on snow.

### BACKGROUND

Continuous track (also called tank tread or caterpillar track), is a system of vehicle propulsion in which a continuous band (having treads or track plates) is supported and driven by multiple wheels or cogs. This band is typically made of modular steel plates in the case of military vehicles and heavy equipment, or synthetic rubber reinforced with steel wires in the case of lighter agricultural or construction vehicles.

The large surface area of the tracks is generally effective to distribute the weight of the vehicle better than steel or rubber tyres on an equivalent vehicle, enabling a continuous tracked vehicle to traverse soft ground with less likelihood of the vehicle becoming stuck due to sinking. Typically, the prominent treads of metal plates are also both hard-wearing and damage resistant, especially in comparison to rubber tyres and, hence, can be used on particularly rough terrain.

Continuous tracks are commonly used on a variety of vehicles including bulldozers, excavators, tanks, and tractors, but can be found on any vehicle used in an application that can benefit from the added traction, low ground pressure and durability inherent in continuous track propulsion systems. In particular, tracks have been designed for snow applications (e.g. snow groomers and snowmobiles).

In the particular application of snow vehicles, a variety of different track systems have been developed as discussed briefly below.

EP 2,778,026 (Schocke) discloses a crawler-track for a ski trail grooming machine. In particular, the drive chain has chain belts divided into main bands and side bands, and several chain web constructions that extend transversely and are fixed to main bands. The chain web constructions are offset transversely from each other and are connected alternately to external or internal side bands with respect to the main bands

U.S. Pat. No. 3,463,562 (Svensson) discloses an endless track for a vehicle having two longitudinally extending parallel, spaced bands which are joined by longitudinally spaced transverse bars, the bands and the bars being, at least in part, integrally formed of an elastomeric material. Each bar comprises in part a U-shaped metal beam. Alternate ones of the bars extend the full width of the track and interspersed with these are shorter bars whose length corresponds substantially to the length of the associated U-shaped beam.

U.S. Pat. No. 3,602,364 (Maglio) discloses a flexible belt formed of hinged segments with two or more segments and preferably separated by spaces. The belt is formed of a suitable plastic, such as an elastomer of the polyurethane type. Using plastic may reduce the weight of the tracks (and increase buoyancy in, for example, marshy terrain). On one side of each segment there are short integral hollow cylinders and mating cylinders on the other side. When two units are placed together the hollow cylinder portions meet to form a substantially complete cylinder in the same manner as a series of hollow cylinders in a hinge for a door. A pin, such as a more or less rigid nylon pin, is passed through the cylinders of the units to form a hinged structure, and this is repeated until endless flexible belts are produced. The units have flat surfaces abutting opposite flat surfaces at the joint, which prevents the hinge opening any substantial amount. The belts are principally useful as snowmobile treads but are also effective for power transmission or for conveyors.

U.S. Pat. No. 4,094,557 (Miller) discloses an articulated endless track used on track-type vehicles. The shoe is formed as a rigid body having a sloping forward planar surface and a sloping rearward surface which each run the length of the shoe and which substantially converge toward each other. Projecting from between the forward and rearward surfaces is a third surface, or traction lug. High-floatation planar bearing surfaces are located on each end of the body and each have a portion adjacent to, and of the same width as the traction lug but increase in width with increasing distance from the lug.

U.S. Pat. No. 4,390,214 (Gunter et al.) discloses a track structure for a crawler track of a crawler vehicle, wherein the track structure comprises an ultra high molecular weight polymeric material having a molecular weight of at least two million.

U.S. Pat. No. 5,897,177 (Bergstrom) discloses a stud for improving the traction of a tread element is provided. The stud includes a body portion including a head and an elongated shank portion extending from the head.

U.S. Pat. No. 7,229,141 (Dandurand et al.) discloses a one-piece track comprising, along each opposite edge thereof, regions having an accordion-type structure, which allows these regions to have a variable longitudinal length along each opposite edge of the track according to a movement of the tracked vehicle and to a corresponding inclination of the track.

US 2004/0004395 (Soucy et al.) discloses an endless track made of a reinforced rubber material with longitudinally spaced and transversely disposed ridges or lugs. It is particularly well-adapted for recreational snowmobiles having a single track. The ground-engaging side of the track features a tread pattern that is repeated over the entire length of the track. The tread pattern comprises a plurality of projecting traction lugs each an upper edge having which together delimit the general outline of a cross-sectional transversal traction lug profile when viewed along a longitudinal direction. The track is characterized in that the traction lug profile comprises a substantially flat central or interior section and two opposite exterior or lateral sections located on the sides of the interior section and that taper toward the exterior. Such track facilitates the steering capabilities of a snowmobile, particularly when the snowmobile is traveling on hard and abrasive surfaces.

US 2009/0224598 (St-Amant et al.) discloses a method for manufacturing a polymeric article having an integrated reinforcing element. A polymeric track for a vehicle may be produced from this method.

US 2016/0257358 (Johnson) discloses an endless, flexible, track for use on track-driven implements comprising an inner surface with modular drive lugs to engage a driving mechanism of the implement.

### SUMMARY

In accordance with the present disclosure, there is provided a track piece for a continuous track drive system wherein the track piece is rotationally asymmetric and comprises connectors, the connectors being configured to enable connection to an adjacent track piece of the same shape which has been rotated 180°.

The track piece may have no rotational symmetry or be rotationally asymmetric about an axis perpendicular to the terrain surface with which the track piece is configured to engage. This asymmetry allows the same track piece to provide multiple gripping configurations depending on its orientation.

Each track piece may be injection molded. Each piece may be injection molded. Suitable manufacturing materials include ultra high molecular weight (UHMVV) polyethylene. UHMW polyethylene may have a molecular mass of greater than 3.5 amu and/or less than 7.5 million amu. UHMW polyethylene provides durability, abrasion resistance and weight advantages over metal and rubber tracks. The track piece may have a unitary polymeric construction with each track piece having a combination of terrain penetration and turning surfaces, a support surface and drive engagement surfaces.

The connectors may comprise a number of connector barrels and corresponding recesses.

The connectors may be configured to be connected to an adjacent track via a connector rod inserted through corresponding barrels to pivotally connect adjacent pieces to one another.

The track piece may include sprocket recesses designed for engagement with individual teeth of a drive sprocket.

The track piece may include a flat flight surface.

The outer portion of the track piece may be tapered to an outer edge.

An inner portion of the track piece may have a sharper taper than the taper of the outer edge. The sharper taper may be a penetrating edge (to penetrate the underlying terrain). The less sharp taper may form a turning edge.

The outer portion may include a support surface with a curved surface that transitions to the flight surface.

The track piece may comprise a grouser mount to enable grousers to be connected. These may prevent lateral movement of the track (e.g. along the axis of each track piece). This may be particularly important when the track is being used on a sloped or banked surface.

In accordance with the present disclosure, there is further provided a continuous track comprising a number of track pieces connected along a central band, wherein the track comprises spaced apart lateral track piece projections.

The gap between successive track piece projections in the direction of the track axis may be at least half of the width of the track piece in the direction of the track axis. The gap between successive track piece projections in the direction of the track axis may be less than 10 times of the width of the track piece in the direction of the track axis.

The length of the projection may be at least half of the length of the overlapping distance transverse to the track axis. The length of the projection may less than 10 times of the length of the overlapping distance transverse to the track axis.

The length of the projection may be at least half of the length of one-track piece. The length of the projection may be less than the length of one-track piece.

The track piece may have a unitary polymeric construction with each track piece having a combination of terrain (snow) penetration and turning surfaces, a support surface and drive engagement surfaces.

The track piece may comprise a flight surface, the flight surface being configured to engage with the underlying surface.

The track piece may be tapered at an outer end. The track piece may be tapered at an inner end. The taper at the inner end may be sharper than the taper at an outer end.

The radius of curvature between the flight and the base may vary along the length of the track piece.

In some embodiments, the track pieces may be rotationally symmetric (e.g. having two-fold rotational symmetry).

In accordance with the present disclosure, there is further provided a continuous track comprising multiple track pieces as described herein.

### BRIEF DESCRIPTION OF THE DRAWINGS

Various objects, features and advantages of the invention will be apparent from the following description of particular embodiments of the invention, as illustrated in the accompanying drawings. The drawings are not necessarily to scale, emphasis instead being placed upon illustrating the principles of various embodiments of the invention. Similar reference numerals indicate similar components.

FIG. 1 is a side view of a track continuous track drive system.

FIG. 2a is a perspective view of a track piece.

FIG. 2b is a top view of the track piece of FIG. 2a.

FIG. 2c is a side view of the track piece of FIG. 2a.

FIG. 2d is a end view of the track piece of FIG. 2a.

FIG. 2e is a top view of four connected track pieces.

FIG. 3a is a cross-section view of a sprocket.

FIG. 3b is a face view of the sprocket of FIG. 3a.

FIG. 4 is a top view of four track pieces forming part of a continuous track drive system.

### DETAILED DESCRIPTION

### Introduction

The present application relates to continuous or “caterpillar” style tracks. The tracks are primarily designed for snow applications (e.g. snow groomers and snowmobiles) but may also be used with some land contact applications.

Presently, various caterpillar tracks are manufactured from metal and rubber elements or a combination of those two. In a typical assembly, a series of repeatable metal linkages (e.g. chain links) may themselves form a continuous track or an underlying linkage may be fitted with an outer rubber belt having outwardly projecting tread elements. In some cases, the outer rubber belt may engage directly with a drive system.

The present design seeks to provide an effective track design that may a) be cheaper to manufacture, maintain and repair and/or b) decrease the weight of current tracks. In particular, as noted above, the present design is particularly effective for snow applications.

Various aspects of the invention will now be described with reference to the figures. For the purposes of illustration, components depicted in the figures are not necessarily drawn to scale. Instead, emphasis is placed on highlighting the various contributions of the components to the functionality of various aspects of the invention. A number of possible alternative features are introduced during the course of this description. It is to be understood that, according to the knowledge and judgment of persons skilled in the art, such alternative features may be substituted in various combinations to arrive at different embodiments of the present invention.

For ease of description, the apparatus of the invention will be described in normal operating position, and terms such as upper, lower, horizontal, etc., will be used with reference to this normal operating position. It will be understood, however, that apparatus may be manufactured, stored, transported and sold in an orientation other than the normal operation position.

### Track System

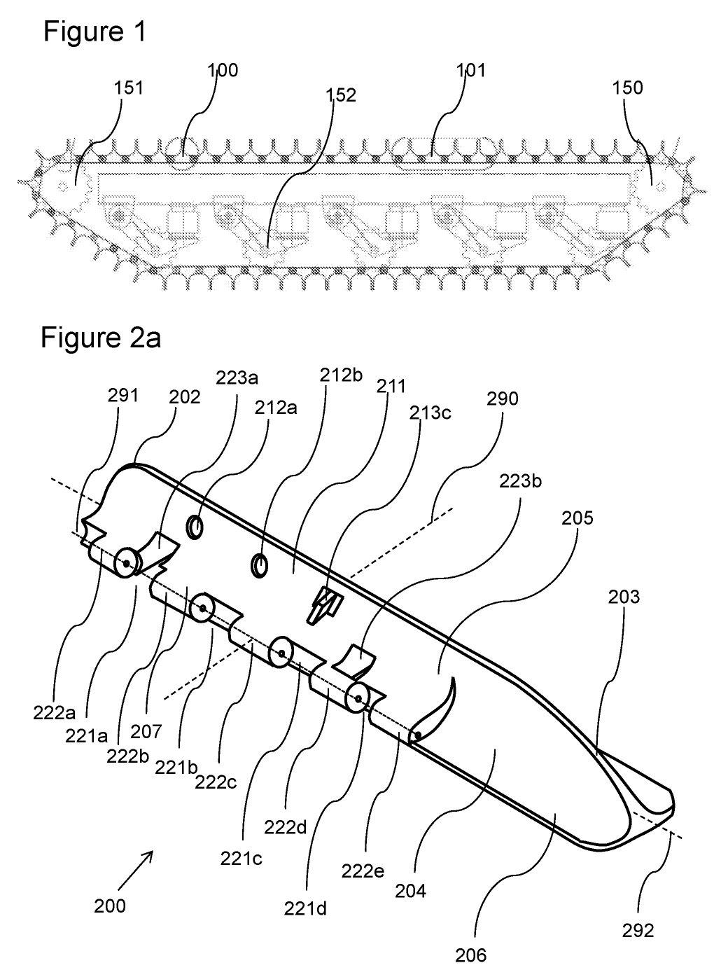

FIG. 1 shows a side view of a continuous or caterpillar track system 10 and

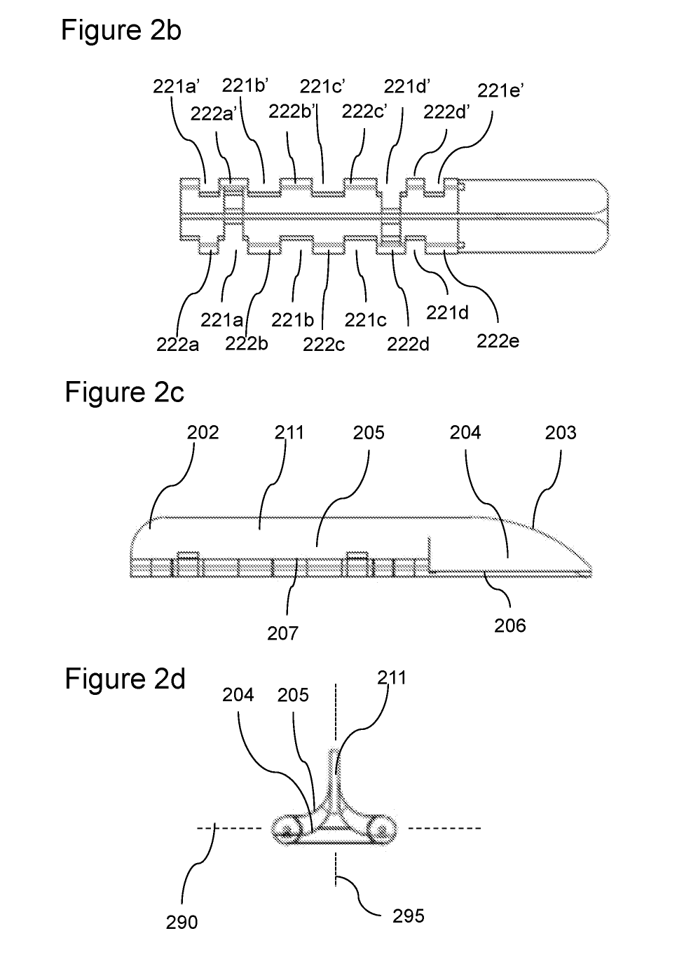

FIG. 2 shows an isometric view of an individual track member 200. Generally speaking, the track system includes:
a track body having a plurality of individual track members 200 defining an inner wheel engaging surface 103 generally adapted to cooperate with multiple rotating members (e.g. 150, 151, 152);
rotating members will typically include one or more of: a drive sprocket 150, a tension sprocket 151, an idler (not shown), top rollers (not shown), bottom rollers 152 and road wheels (not shown); and
an outer ground engaging surface 104 generally adapted to provide traction to the vehicle. In this case, the track body and the outer ground engaging surfaces are provided by the interconnected track pieces 100.

A drive system will typically include at least one drive sprocket and at least one tensioning sprocket. It will be appreciated that other configurations of tracks and sprockets may be used. In this case, the track comprises multiple track pieces 100 which are joined directly to each other. Different track systems are designed for different applications and will have a number of features incorporated into them depending on the application.

The track 101 forms a continuous loop around the sprockets and defines a track axis 290 that is generally aligned to the direction of travel. This is usually the case when the track is moving without slippage. That is the track axis may not be aligned to the direction of travel, for example, when skid steering.

As best shown in FIGS. 2a-2d, track pieces 100 in accordance with one embodiment of the invention are described. Each track piece generally includes track piece connectors 221, 222, and snow contacting surfaces 202-205, 211.

### Track Piece Connectors

FIGS. 2a-2c shows a single track piece 200 that can be interconnected to form a continuous loop that may be configured to a vehicle drive system (as shown in FIG. 1). Such an individual track piece may be used on a snow groomer, snowcat or snowmobile. A typical snow groomer or snowcat will have two or more track assemblies (e.g. one or two track assemblies on each side) whereas a snowmobile will typically have one track assembly (e.g. at the back).

In the present embodiment, each track piece is rotationally asymmetric. This means that the track piece has no rotational symmetry. Rotational symmetry is the property a shape has when it looks the same after some rotation by a partial turn. In some embodiments, the track piece may have reflection symmetry, e.g. with a mirror plane normal to the track axis.

In order to enable, track piece inter-connectability, each track piece includes connectors 222a-e, 221a-d, 222a′-d′, 221a′-e′, the connectors being configured to enable connection to an adjacent track piece of the same shape which has been rotated 180° (see FIG. 2d). This means that when connected, the longer end of this track piece embodiment alternates between one side and the other along the track axis. That is, this configuration allows two distinct gripping surfaces to be generated using a single type of track piece. The connectors may be configured to limit the bending angle between connected track pieces (e.g. to less than 40° or less than 30° from a planar configuration).

This would form a p2 frieze pattern (IUC notation) around the track axis. This group is generated by a translation and a 180° rotation.

Specifically, each track piece is interconnected via a number of connector barrels 222a-e, 222a′-d′ and corresponding recesses 221a-d, 221a′-e′. As shown in FIG. 2d, the positioning of the barrels and recesses of individual pieces allow adjacent pieces to be connected in a 180° orientation with respect to one another. A connector rod is inserted, along a connector rod axis 291, through corresponding barrels to pivotally connect and lock adjacent pieces to one another.

Connecting the track in this way so that each successive track piece is rotated by 180° allows a track with different contact surfaces to be made using multiple track pieces of the same shape. That is, if a series of similar-shaped track pieces are connected without rotation (e.g. in a p1 frieze group generated by translation only), the periodic pattern would result in only one repeating type of contact surface. Relying on one type of contact surface may result in inferior traction (e.g. when the track is stuck or mired in mud or snow and slippage is occurring) and/or turning operability. As such, to provide different or alternating drive surfaces, the track is assembled using identical but alternately rotated track pieces.

Therefore, as explained in greater detail below, the present invention allows a track with two types of drive surface to be assembled using a single track piece shape. It will be appreciated that this may reduce repair or maintenance requirements. For example, a repair person need only carry one type of track piece which can replace tracks in either orientation. It may also allow a track piece to be re-used in a rotated configuration. For example, if one side of the drive surface is worn, the track piece may still be used in a rotated configuration.

The connectors comprise a number of connector barrels 222a-e, 222a′-d′ and corresponding recesses 221a-d, 221a′-e′. The connectors are configured to be connected to an adjacent track via a connector rod inserted through corresponding barrels to pivotally connect adjacent pieces to one another. In this case, the connector rods are configured to be transverse (e.g. perpendicular) to the track axis 290. In other embodiments, the connector rod may not be perpendicular to the track axis.

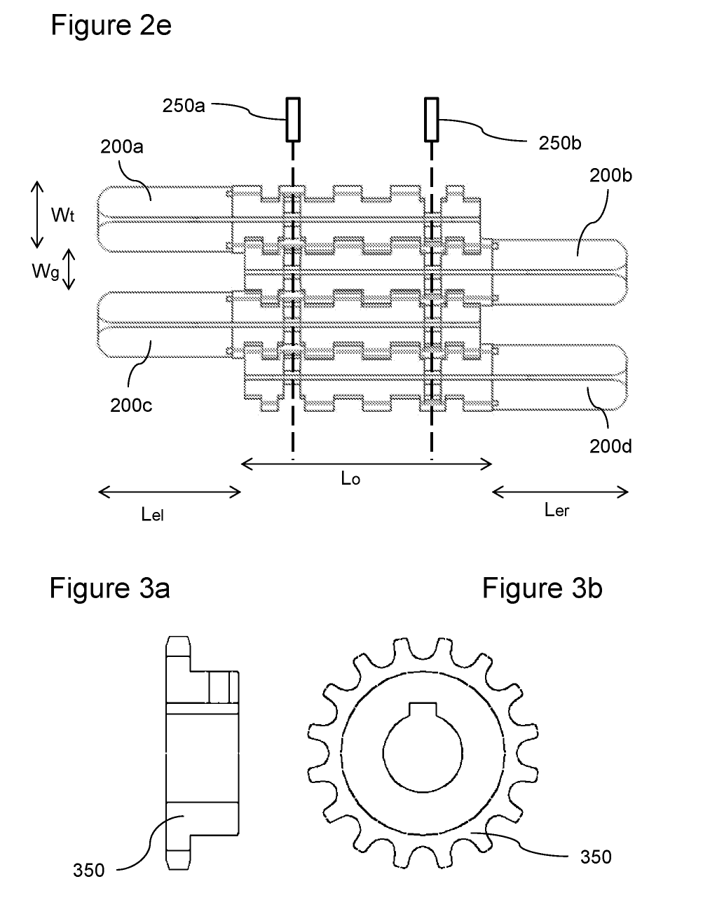

The track piece includes one or more sprocket recesses 223a, 223b designed for engagement with individual teeth of a drive sprocket. In this case, there are two sprocket recesses displaced laterally along the track piece axis 292. Typically, a sprocket will engage with the underside of an individual piece and the middle of an assembled track assembly. As shown, the connector barrels 222d, 222a′ at the recesses 223a, 223b are generally designed to have a curvature that will smoothly engage with the valley of each sprocket tooth. A sprocket 350 with curved teeth is shown in FIGS. 3a and 3b.

The track piece includes a main flight surface 211. This may be flat in, for example a snowcat application. The flight surface is a planar projection which lies in a plane 295 which is transverse to (e.g. normal or perpendicular to) the track axis (where the surface intersects with the track axis). The flight surface is configured to engage with the underlying surface (e.g. by digging into or penetrating the snow or ground below the vehicle) to provide traction when the continuous track is driven over the underlying surface.

The outer portion of each piece (e.g. the flight surface 211) is tapered to an outer edge 203. The taper allows better pivoting of the vehicle (e.g. snowcat) when turning. That is, the sharper taper 203 may form part of a turning edge.

The inner portion of each piece (e.g. the flight surface 211) has a sharper taper 202. This sharper taper, which after assembly, is generally towards the middle of the assembled track allows for better underlying surface penetration (e.g. snow). That is, the sharper taper 202 may form part of a penetrating edge configured to dig into the terrain. It may be positioned close to the weight-transferring components of the track assembly to concentrate the pressure on this portion and to restrict deformation of the track (which may hinder penetration of the track piece).

In this case, the outer portion includes a support surface 206 (e.g. a snow support surface) with a deep curve 204 that transitions to the flight surface. The (snow) support surface on the inner portion has a shallower curve 205 that transitions between the support surface 207 and the flight surface. That is, the radius of curvature between the (snow) support surfaces and the flight surfaces is greater at the outer edge and smaller on the inner portion (the radius of curvature can be best seen in FIG. 2c). In this case, inner and outer are defined in terms of lateral distance to the drive wheels (e.g. drive sprocket).

The (snow) support surface may be considered to lie in a plane aligned with the track axis and transverse to the plane in which the looped track axis lies. The plane in which the looped track axis in FIG. 1 would be parallel to the plane of the page. That is, in this case, the plane in which the looked track axis lies is parallel to the track piece axis 292. Therefore, in this case, the support surfaces are parallel to (or aligned with) the track axis 290 and to the track piece axis 292. The (snow) support surfaces are configured to lie on top of the underlying support surface (snow, mud, or soil) to distribute the weight of the vehicle (i.e. lower the pressure exerted on the underlying surface).

In this case, one or more (or all) of the track pieces include grouser mounts 212a, 212b to enable grousers 213c to be connected (mounts and grouser shown only in FIG. 2a). Grousers are projections which can be used in snow applications to prevent lateral slippage of the machine when traversing inclined slopes. Grousers will be attached as required depending on the application. In this case, the grousers are mounted to the side of the flight. That is, the grousers are mounted to the track piece on a plane which is transverse (e.g. normal) to the track axis.

As shown in FIG. 2a, arranging the track by each track piece being connected to two adjacent track pieces forms a continuous track comprising a number of track pieces connected along a band, wherein the track comprises spaced apart lateral track piece projections. The central band in this case is the common area which is swept by all of the individual track pieces. That is, as shown in FIG. 2a, this central band corresponds to the band with the width Lₒ. For example, the projections may not form part of the band because the gaps may mean that there is a portion which is not swept out by at least one of the individual track pieces. The band may be central to the full width of the continuous track. E.g. in FIG. 2d where there are corresponding projection lengths Lₑₗ and Lₑᵣ on either side of the central band. The band may correspond to or enclose one or more drive axis which lie parallel to the track axis and in line with the drive wheels or sprockets 250a, 250b.

The width of the gap, W_{g}, between successive track piece projections in the direction of the track axis may be at least half of the width of the track piece, Wₜ, in the direction of the track axis. This gap may allow snow or dirt to be ejected from inside the track as it moves along. The projections may only be supported by the inner portion of the track. That is, the projections may extend beyond any support which extends around and parallel to the track axis.

The length of the projection, Lₑᵣ, Lₑₗ, (or alternatively the length of the gap) is at least half of the length of the overlapping distance, Lₒ, transverse to the track axis.

The length of the projection is at least half of the length of one track piece. These projections may loser the pressure of the vehicle on the underlying surface. The projections may also increase the effective area of the underlying surface which is supporting the vehicle (e.g. this may be larger than the contact surface of the continuous track depending on how force is transmitted laterally by the underlying surface).

### Track Piece Projections

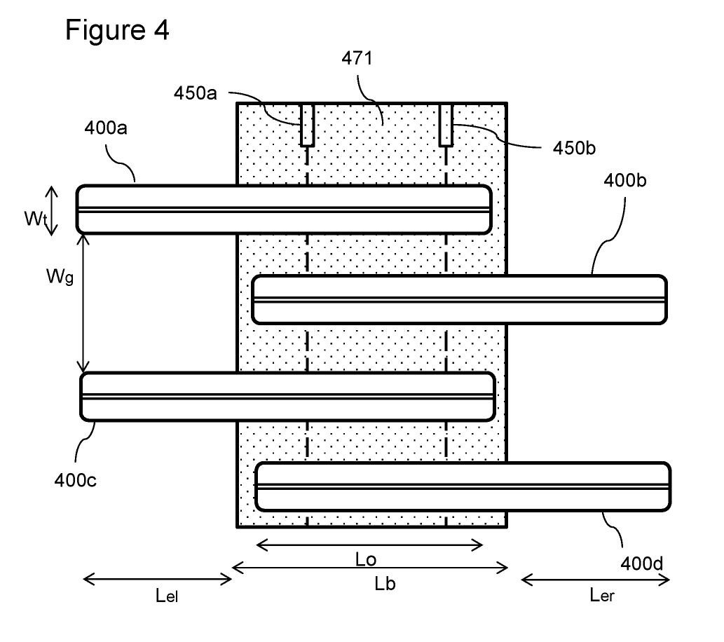

FIG. 4 shows an alternative continuous track comprising a number of track pieces connected along a central band (which in this case is a belt 471), wherein the track comprises spaced apart lateral track piece projections.

In this case, the construction of the track is different to the previous case in which successive track pieces where connected to each other. In this case, each track piece is connected to a common belt. In this case, the projection (or gap) lengths, Lₑₗ and Lₑᵣ, are defined in terms of the unsupported length of the track pieces which extend beyond the width of the belt 471. In this case, length of the projection, Lₑᵣ, Lₑₗ, is at least half of the length of the supported width, L_{b}, transverse to the track axis.

Each piece may be injection molded. Suitable manufacturing materials include ultra high molecular weight (UHMVV) polyethylene. UHMW polyethylene may have a molecular mass of greater than 3.5 amu and/or less than 7.5 million amu. UHMW provides durability, abrasion resistance and weight advantages over metal and rubber tracks. The track piece may have a unitary polymeric construction with each track piece having a combination of terrain penetration and turning surfaces, a support surface and drive engagement surfaces.

In particular, injection molded pieces are substantially less expensive and a lower weight while providing appropriate durability and performance. This will translate to lower operating costs to an operator.

The radius of curvature between the flight and the support surface may vary along the length of the track piece. In this case, there is a step transition between the support surface at the outer end of the track and the support surface of the inner portion of the track to provide a flat vertical surface for inserting the connector rod. This may help prevent lateral movement of the track.

The assembled tracks can also be incorporated on to other machines including excavators, bucket loaders and other machinery and vehicles.

One particular application is the use on vehicles navigating softer ground (e.g. swampy or boggy ground) where vehicle weight and buoyancy may be an issue. Other applications may be on surfaces where it is desired to minimize the damage to the surface.

Although the present invention has been described and illustrated with respect to preferred embodiments and preferred uses thereof, it is not to be so limited since modifications and changes can be made therein which are within the full, intended scope of the invention as understood by those skilled in the art.

1. A track piece for a continuous track drive system wherein the track piece is rotationally asymmetric and comprises connectors, the connectors being configured to enable connection to an adjacent track piece of the same shape which has been rotated 180°.

2. The track piece of claim 1, wherein the connectors comprise a number of connector barrels and corresponding recesses.

3. The track piece according to claim 1, wherein the connectors are configured to be connected to an adjacent track via a connector rod inserted through corresponding barrels to pivotally connect adjacent pieces to one another.

4. The track piece according to claim 1, wherein the track piece includes sprocket recesses designed for engagement with individual teeth of a drive sprocket.

5. The track piece according to claim 1, wherein the track piece includes a flat flight surface.

6. The track piece according to claim 1, wherein an outer portion of the track piece is tapered to an outer edge.

7. The track piece of claim 6, wherein an inner portion of the track piece has a sharper taper than the taper of the outer edge

8. The track piece according to claim 6, wherein the outer portion includes a support surface with a curved surface that transitions to the flight surface.

9. The track piece according to claim 1, wherein the track piece comprises a grouser mount to enable grousers to be connected.

10. A continuous track comprising a number of track pieces connected along a central band, wherein the track comprises spaced apart lateral track piece projections.

11. The continuous track of claim 10, wherein the gap between successive track piece projections in the direction of the track axis is at least half of the width of the track piece in the direction of the track axis.

12. The continuous track according to claim 10, wherein the length of the projection is at least half of the length of the overlapping distance transverse to the track axis.

13. The continuous track according to claim 10, wherein the length of the projection is at least half of the length of one track piece.

14. A track piece for a continuous track drive system, the track piece having a unitary polymeric construction with each track piece having a combination of terrain penetration and turning surfaces, a support surface and drive engagement surfaces.

15. The track piece according to claim 14, wherein the track piece comprises a flight surface, the flight surface being configured to engage with and be supported by the underlying terrain surface.

16. The track piece according to any claim 14, wherein the track piece is tapered at an outer end to allow the track piece to pivot.

17. The track piece according to claim 14, wherein the track piece is tapered at an inner end of each piece to allow the track piece to penetrate the underlying terrain.

18. The track piece according to claim 17, wherein the taper at the inner end is sharper than the taper at an outer end.

19. The track piece according to claim 14, wherein the radius of curvature between the flight and the base varies along the length of the track piece.

20. A continuous track comprising multiple track pieces according to claim 14.
